(19) United States
(12) Patent Application Publication
(10) Pub. No.: US 2011/0251909 A1
(43) Pub. Date: Oct. 13, 2011

(54) CREDIT CARD PAYMENT SYSTEM FOR HANDLING NUMEROUS PAYORS

(76) Inventor: Clark S. Clark, Miami, FL (US)

(21) Appl. No.: 13/084,529

(22) Filed: Apr. 11, 2011

Related U.S. Application Data
(60) Provisional application No. 61/322,542, filed on Apr. 9, 2010.

(51) Int. Cl. G06Q 20/00; G06Q 40/00; G06K 7/01; G06K 7/08

(52) U.S. Cl. 705/17; 235/449; 235/379; 235/439; 705/39

(57) ABSTRACT

A method, apparatus, computer system and computer program product for managing a plurality of credit card payments over a communications network is disclosed. The apparatus of the present invention includes a plurality of slots, each allowing for insertion of a card. Each slot includes a sensor for reading information from a card inserted into the slot and a moving mechanism for ejecting a card inserted into the slot. The apparatus further includes a processor communicatively coupled with each sensor and moving mechanism associated with each slot, wherein the processor is configured for receiving data read by the sensors and sending an actuation command to the moving mechanisms. The apparatus further includes a communications module communicatively coupled with the processor for sending data read by the sensors and receiving commands for actuating the moving mechanisms.

### CROSS REFERENCE TO RELATED APPLICATIONS

This patent application claims priority to provisional patent application 61/322,542 filed Apr. 9, 2010. This patent application hereby incorporates by reference the subject matter of provisional patent application 61/322,542 in its entirety.

### BACKGROUND OF THE INVENTION

1. Field of the Invention

The present invention relates to the field of electronic commerce and, more specifically, the present invention relates to the field of credit and charge card processing over a communications network.

2. Description of the Related Art

Restaurants and bars are examples of point of sale locations where credit cards and charge cards are used for a high percentage of the sales transactions. Often, these high-traffic locations process hundreds, sometimes thousands, of credit and charge cards in a short period of time. Because of the large number of attendants/servers processing credit cards, the large number of consumers purchasing items, the presence of alcohol, the late hours of operation and the often low lighting levels present at these point of sale locations, errors and miscalculations often occur during the processing of purchases. Consequently, the profitability of high-traffic point of sale locations can easily be affected by the accuracy and efficiency of their credit card processing practices.

Typically, when a consumer opens a tab at an establishment, the consumer gives his identification, such as a driver's license, and credit or charge card to the attendant, waiter, server or bartender. The attendant then processes the credit card for pre-authorization. Usually, the attendant places the identification and credit card in a cup or other central location. Subsequently, as the consumer purchases goods and/or services, the attendant must enter the purchases into a computerized accounting system. When the consumer is ready to settle his account, the attendant must tally the consumer's account at the computerized accounting system, effectuate a charge to the consumer's credit card, print one or more receipts and then find the consumer's identification and credit card so as to return it to the consumer. Finally, the identification and credit card are returned to the consumer and the consumer is given receipts for his signature and/or safekeeping.

In light of the difficulties associated with high-traffic point of sale locations, errors and omissions can occur in any one of credit card processing steps described above. The server may place the credit card or identification in a non-central location, thereby losing it, the server may return the credit card or identification to the wrong consumer or the server may simply forget to return the identification or credit card. This can be annoying to consumers and can lead to a loss of credibility of the establishment. More commonly, purchases by one consumer can accidentally be placed on the credit card of another consumer. This can also irritate consumers.

Another common problem associated with high-traffic point of sale locations is the occurrence of charge backs. A charge back occurs when a consumer decides not to pay for goods or services by cancelling payment through their credit card provider or bank. Historically, charge backs can account for or exceed 1-2% of a merchant's profitability. The most common reason a consumer may dispute a credit card charge is a customer's claim, often fabricated, that he did not incur the disputed charge. If the merchant does not keep appropriate records of the consumer's credit card and identification, he is not able to adequately contest the charge back. Lastly, another pitfall of point of sale transactions is the verification of age when alcohol is being sold. If a consumer's age is not verified or is incorrectly identified as over age in the course of selling alcohol, the merchant may experience civil as well as criminal penalties that may include losing their liquor license.

Therefore, what is needed is a system and method for improving the problems associated with the prior art, and more particularly for a more efficient method and system for managing credit card charges at high-traffic point of sale locations.

### BRIEF SUMMARY OF THE INVENTION

Embodiments of the present invention address deficiencies of the art in respect to electronic commerce and provide a novel and non-obvious method, apparatus, computer system and computer program product for managing a plurality of credit card payments over a communications network. In an embodiment of the invention, the apparatus of the present invention includes a plurality of slots, each allowing for insertion of a card. Each slot includes a sensor for reading information from a card inserted into the slot and a moving mechanism for ejecting a card inserted into the slot. The apparatus further includes a processor communicatively coupled with each sensor and moving mechanism associated with each slot, wherein the processor is configured for receiving data read by the sensors and sending an actuation command to the moving mechanisms. The apparatus further includes a communications module communicatively coupled with the processor for sending data read by the sensors and receiving commands for actuating the moving mechanisms.

In another embodiment of the invention, the apparatus, computer system, method and computer program product of the present invention for managing a plurality of credit card payments over a communications network performs the following steps: reading information from a credit card inserted into a card processing apparatus; establishing an account associated with the credit card, wherein a name on the credit card is associated with the account; entering at least one charge associated with the account; sending a payment request to a payment gateway over a communications network, wherein the payment request includes data associated with the account and any charges associated with the account; receiving a payment acknowledgement from the payment gateway; and sending an actuation command to a moving mechanism coupled with the credit card processing apparatus, wherein the moving mechanism is configured for ejecting the credit card when actuated.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for managing a plurality of credit card payments over a communications network, in accordance with one embodiment of the present invention.

FIG. 2 is a block diagram illustrating a computer system for managing a plurality of credit card payments over a communications network, in accordance with one embodiment of the present invention.

FIG. 3 is an illustration of an apparatus used in facilitating the management of a plurality of credit card payments over a communications network, in accordance with one embodiment of the present invention.

FIG. 4 is a block diagram illustrating components of the apparatus of FIG. 3.

FIG. 5 is a flow chart describing the control flow of the process for opening and closing an account or tab using the system of one embodiment of the present invention.

### DETAILED DESCRIPTION OF THE INVENTION

The present invention improves upon the problems with the prior art by providing a more effective and efficient method and system for managing the payment processing of a plurality of credit cards over a communications network such as the Internet. The present invention improves over the prior art by reducing the number of steps that must be carried by a server/attendant in a scenario that involves multiple credit cards and multiple charges, thereby simplifying the situation and reducing the possibilities of human errors and omissions. The present invention also reduces or eliminates the occurrence of lost or misplaced credit cards of identifications because the apparatus of the present keeps and organizes all of the cards entered into the system, and regulates its release upon closing of an account. The present invention also diminishes the chances of an attendant or server returning the credit card or identification to the wrong consumer or the server forgetting to return the identification or credit card, since the apparatus of the invention releases the credit card and identification when the card or identification is ready for return. This reduces annoyance of consumers and increases the credibility of the establishment. The present invention also decreases the potential of an attendant or server accidentally placing the wrong charges on the credit card of a consumer, since the apparatus of the invention only allows charges to be entered upon the charge card of an authorized credit card.

The present invention further improves over the prior art by reducing charge backs and increasing a merchant's profitability. By logging each consumer's credit card and identification information, a consumer can no longer dispute a credit card charge using the premise that he did not incur the disputed charge. Lastly, the present invention offers age verification, thereby reducing or eliminating the chances of experiencing civil as well as criminal penalties related to serving alcohol to underage persons.

It should be noted that the term “card” is used to refer to a credit card, a charge card, a driver's license, a membership card, or any type of card, usually made of plastic and carried in a person's wallet or purse, which may or may not include raised lettering, a magnetic strip and/or a data chip. The term “information from a card” refers to any data that can be garnered from a card, including from reading raised lettering on the card, reading data from a magnetic strip on the card or reading any data embedded in a chip, microprocessor, storage medium or memory on the card. The term “credit card” is used to refer to a credit card, a charge card, a bank card, a payment card, a gift card, or any type of card, usually made of plastic and carried in a person's wallet or purse, which is used to make purchases by charging an account via a networked payment system. The term “motor” is used to refer to a mechanism powered by any means, including electrical, pneumatic, and hydraulic, that creates a movement upon being activated by its power means.

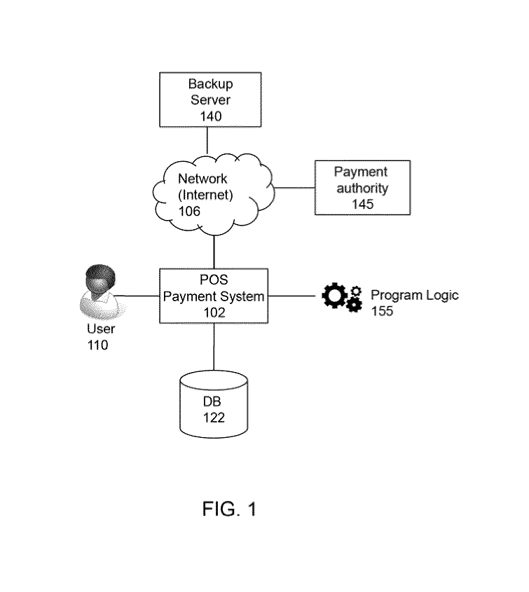

Referring now to the drawing figures in which like reference designators refer to like elements, there is shown in FIG. 1 a block diagram illustrating a network architecture of a system for managing a plurality of credit card payments over a communications network, in accordance with one embodiment of the present invention. FIG. 1 shows an embodiment of the present invention wherein a user 110, who may be any point of sale worker, such as a server, attendant, cashier, waiter or bartender, interacts with the point of sale (POS) payment system 102 of the present invention over a network 106, which can be a packet switched network such as the Internet or the World Wide Web, or the public telephone system. The computer or computers of the payment system 102 can be desktops, laptops, handheld computers, tablet computers, smart phones, or the like.

POS payment system 102 is the main operative element of the present invention, executing the steps that comprise the method of the present invention. System 102 includes a software engine that performs those actions necessary to carry out the present invention, including data processing and transmission and reception of data from other entities, such as the payment authority 145. It should be noted that although FIG. 1 shows only one user 110 and one payment system 102, the system of the present invention supports any number of client users and payment systems 102 connected via network 106. The present invention also supports any number of payment authorities.

POS payment system 102 includes program logic 155 comprising computer source code, scripting language code or interpreted language code that is compiled to produce computer instructions that perform various functions of the present invention. In one embodiment of the present invention, the program logic 155 is a scripting language. Program logic 155 may reside on a single computer of the system 102, on multiple computers of the system 102, or may be distributed among one or more computers of system 102 and external entities, such as payment authority 145. FIG. 1 further shows that system 102 is connected to a database 122, which is used to store consumer records, transactions, profiles and other consumer account data, which have been created during the processing of credit card payments by system 102.

FIG. 1 also shows a payment authority 145 to effectuate payments by consumers, as entered by the user 110. The payment authority 145 may be an acquiring bank, i.e., the bank or financial institution that accepts credit and or debit card payments for products or services on behalf of a merchant, a payment processor, a third party appointed by a merchant to handle credit card transactions for merchant banks, or a payment gateway, i.e., an e-commerce Application Service Provider (ASP) service that authorizes payments for individuals, e-businesses, online retailers, or traditional brick and mortar businesses. A payment gateway facilitates the transfer of information between a merchant and the acquiring bank.

FIG. 1 also shows a backup server 140 which makes copies of data on system 102 and/or its associated database 122, so that these additional copies may be used to restore the original after a data loss event. The backup server 140 may be used to restore a state following a disaster or to restore small numbers of files after they have been accidentally deleted or corrupted.

Note that although system 102 is shown as a single and independent entity, in one embodiment of the present invention, the functions of system 102 may be integrated with the functions of another entity, such as entities 140 and 145 of FIG. 1. Further, system 102 and its functionality, according to a preferred embodiment of the present invention, can be realized in a centralized fashion in one computer system, or in a distributed fashion where different elements are spread across several interconnected computer systems.

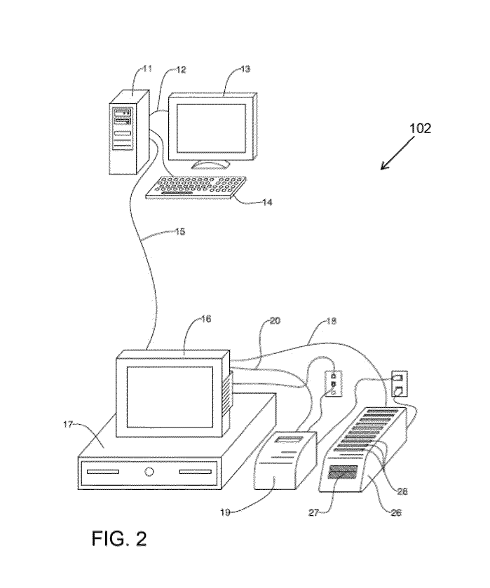

FIG. 2 is a block diagram illustrating a computer system 102 for managing a plurality of credit card payments over a communications network 106, in accordance with one embodiment of the present invention. FIG. 1 provides more detail about system 102 presented in FIG. 1. FIG. 1 shows a POS payment system 102 including, in one embodiment, a point of sale computer 11 connected to monitor 13 through a cable 12 and a keyboard 14.

The point of sale computer 11 is also connected to point of sale terminal 16 through another cable 15. A cash drawer may also be associated with POS terminal 16. The POS terminal 16 may also be connected to a printer 19 through a cable 20 and to the card processing apparatus 26 through a cable 18. The card processing apparatus includes a set of slots 28 and one or more communications ports 27, which may be Ethernet ports.

A point of sale accounting system, which maintains consumer accounts, keeps track of each charge associated with each consumer account, and opening and closing accounts or tabs, may reside on point of sale computer 11, POS terminal 16, card processing apparatus 26, or any combination of the three. Likewise, a payment processing system, which communicates with a payment gateway 145 over a communications network to authorize credit cards and effectuate payments, may reside on point of sale computer 11, POS terminal 16, card processing apparatus 26, or any combination of the three.

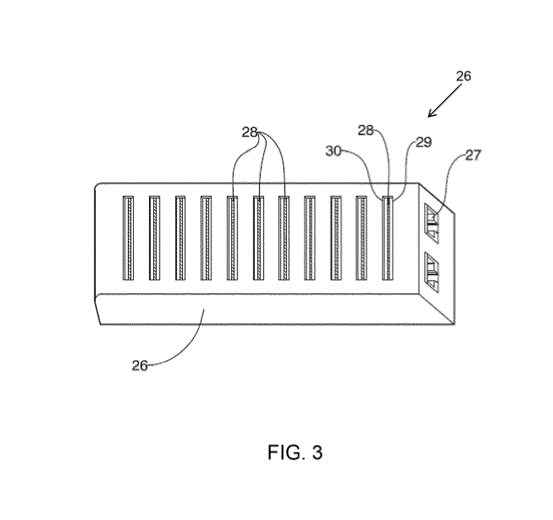

FIG. 3 is an illustration of the card processing apparatus 26 used in facilitating the management of a plurality of credit card payments over a communications network 106, in accordance with one embodiment of the present invention. FIG. 3 shows that every slot 28 may include an upper LED 29 and a lower LED 30. The function of the LED lights 29-30 is to identify slot availability. Each slot 28 reads and stores individual cards for security, organization and efficiency in the opening, closing and storage process of credit card accounts. The card processing apparatus 26 also includes one or more communications ports 27, which may any one of a serial port, a parallel port, a USB port, an IEEE 1394 port, or the like. Instead of wired link, the card processing apparatus 26 may alternatively, or additionally, communicate using a wireless Bluetooth transmitter/receiver and/or a wireless IEEE 802.11 transmitter/receiver.

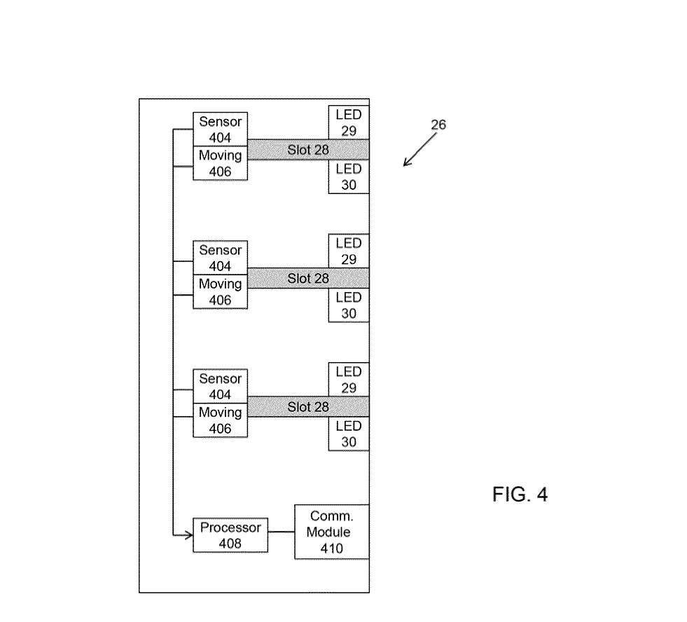

FIG. 4 is a block diagram illustrating components of the card processing apparatus 26 of FIG. 3. FIG. 3 shows that each slot 28 is associated with a sensor 404, a moving mechanism 406, a top LED 29 and a lower LED 30. The processor 408 is communicatively coupled with the sensors 404, moving mechanisms 406, top LEDs 29 and lower LEDs 30, such that the processor 408 can receive data read by the sensors 404, transmit actuation commands to the moving mechanisms 406, and transmit on and off signals to top LEDs 29 and lower LEDs 30. The processor 408 is also communicatively coupled with the communications module 410.

The sensors 404 may be any one of a magnetic strip reading mechanism, a raised lettering reading mechanism and a storage medium reading mechanism. The moving mechanisms 406 may be any one of a spring activated latch that releases a loaded spring upon receiving an actuation command from the processor 408. When a card is inserted into a slot 28, a spring is loaded a latch prevents the spring from expanding. When an actuation command is received by the moving mechanism 406 from the processor 408, the latch releases the loaded spring, thereby ejecting the card. In another alternative, the moving mechanisms 406 may be a motor that commences movement upon receiving an actuation command from the processor 408. When an actuation command is received by the moving mechanism 406 from the processor 408, the motor begins movement, which pushes or pulls the card from its slot. Note that although FIG. 3 shows only three slots 28, the present invention supports any number of card slots.

Both sensors 404 and moving mechanisms 406 can be used to detect the presence of a card in a slot 28. Communicatively coupled with processor 408, both sensors 404 and moving mechanisms 406 can transmit messages to the processor 408 indicating the presence of a card in the corresponding slot 28.

In one embodiment, the processor 408 is configured for sending the data received from the sensors 404 to the communications module 410, which is configured for sending the data received from the sensors 404 to the point of sale accounting system, and/or the payment processing system. In another embodiment, the processor 408 is configured for sending an actuation command to a particular moving mechanism 406 upon receiving a command for actuating the moving mechanism 406 from the communications module 410, and wherein the payment processing system (which may be contained in systems 11 or 16) is configured for sending a command for actuating the moving mechanism 406 to the communications module 410 upon receiving a payment acknowledgement from the payment authority 145.

In yet another embodiment, the processor 408 is configured for sending an “on” or “off” command to LEDs 29 or 30. One LED may be used to designate when a slot is available, while the other is used to indicate the slot is occupied. Assuming LED 29 indicates availability and LED 30 indicates occupation, upon a slot 28 becoming available, the processor 408 is configured for sending an “on” command to LED 29 and an “off” command to LED 30. Upon a slot 28 becoming occupied, the processor 408 is configured for sending an “off” command to LED 29 and an “on” command to LED 30.

The communications module 410, communicatively coupled with the processor 408, may be a network interface card, and may further comprise any one of a serial port, a parallel port, a USB port, an IEEE 1394 port, a wireless Bluetooth transmitter/receiver and a wireless IEEE 802.11 transmitter/receiver.

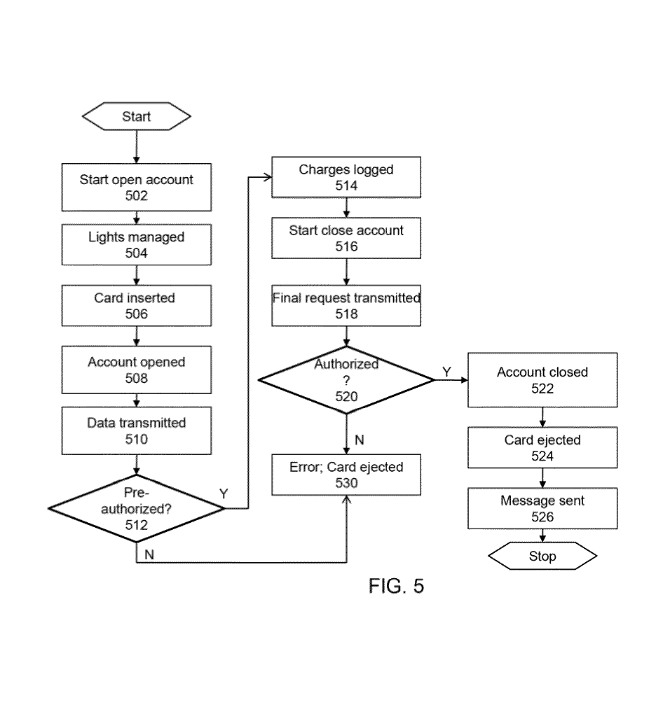

FIG. 5 is a flow chart describing the control flow of the process for opening and closing an account or tab using the system 102 of one embodiment of the present invention. FIG. 5 describes the steps that occur when an attendant or server for a merchant opens an account or tab using the system 102 of the present invention. The steps of FIG. 5 may be performed by program logic 155. FIG. 5 is described with reference to FIG. 1 above.

In a first step 502, the user 110 interacts with the system 102, such as via an interface, to open a new account. In step 504, the processor 408 sends an “on” command to an LED 29 and an “off” command to LED 30 to indicate a slot 28 is available. In step 506, the user 110 inserts a credit card into a slot 28 indicated as available by the LEDs, and the sensor 404 reads any or all of the data from the credit card. Then, the processor 408 sends an “off” command to an LED 29 and an “on” command to LED 30 to indicate a slot 28 is occupied.

In one embodiment, in step 506, the user 110 additionally inserts an identification card into a slot 28, wherein the sensor 404 reads any or all of the data from the identification card. The data read from the credit card and/or identification card may include name, address, phone number, card number, ID number, access code, security code, or the like. Further, sensors 404 and/or moving mechanism 406 may detect the presence of a card in the corresponding slot and transmit a message to the processor 408 indicating the presence of the card in the corresponding slot 28.

In step 508, the system 102 creates an account for the consumer owning the card and associates any of the data read from the credit card and/or identification card with the account. Any of the account data may be transmitted to the point of sale accounting system, the payment processing system, or both. In step 510, the system 102 transmits some or all of the data associated with the account to the payment authority 145 via network 106. In step 512, it is determined whether the payment authority 145 pre-authorizes charges to the credit card. If a pre-authorization is received from the payment authority 145, then control flows to step 514. Otherwise, control flows to step 530.

Optionally, in steps 510-512 above, the system 102 also determines whether the consumer owning the credit card is of a certain age. The system 102 may transmits some or all of the data associated with the account to the payment authority 145, or a separate authority for verifying age, via network 106. It is assumed that a payment authority has an implicit ability to verify certain age minimums. Then, it is determined whether the payment authority 145, the other authority or the system 102 itself, verifies the consumer owning the credit card is of a certain age. If a verification is received from the payment authority 145, the other authority or the system 102 itself, then control flows to step 514. Otherwise, control flows to step 530.

In another alternative, in steps 510-512 above, the system 102 also determines whether the name on the credit card matches the name given on the consumer's identification card. If there is a match, then control flows to step 514. Otherwise, control flows to step 530.

In step 514, the user 110 adds charges, i.e., purchases by the consumer, to the account, such as via the interface. Optionally in step 514, for every charge added to the account, the system 102 transmits some or all of the data associated with the account to the payment authority 145 via network 106 in order to garner authorization for the new charge. If an authorization is received from the payment authority 145, then control flows to step 516. Otherwise, control flows to step 530.

In step 516, the user 110 interacts with the system 102 to close the account. In step 518, the system 102 sends a final request for payment to the payment authority 145 via network 106. In step 518, the system 102 transmits some or all of the data associated with the account to the payment authority 145 via network 106. In step 520, it is determined whether the payment authority 145 authorizes the charges to the credit card. If an authorization is received from the payment authority 145, then control flows to step 522. Otherwise, control flows to step 530.

In step 522, the account automatically closes out and a receipt is printed by system 102 for signature by the consumer. In step 524, the consumer's card is ejected from the apparatus 26. Then, the processor 408 sends an “on” command to an LED 29 and an “off” command to LED 30 to indicate the corresponding slot 28 is available. Step 524 may execute as follows: upon receiving a payment acknowledgement from the payment authority 145, payment processing system (which may be contained in systems 11 or 16) sends a command for actuating the moving mechanism 406 to the communications module 410, and the processor 408 may send an actuation command to a particular moving mechanism 406 upon receiving a command for actuating the moving mechanism 406 from the communications module 410. The moving mechanism 406 is then actuated to eject the card from the corresponding slot 28.

In step 526, the system 102 transmits a message to an owner of the card over the communications network 106, wherein the message includes data associated with any charges associated with the account. The message may be an email, a text message or any other electronic message sent over the network 106. The message may include a receipt that includes any and all charges placed on the consumer's account in step 514 above.

In step 530, an error message indicating the problem is displayed for the user 110 and the card is ejected from the slot 28 in the apparatus 26. Then, the processor 408 sends an “on” command to an LED 29 and an “off” command to LED 30 to indicate the slot 28 is available. Step 530 may execute as follows: upon receiving a declination from the payment authority 145 (or other authority), the payment processing system sends a command for actuating the moving mechanism 406 to the communications module 410, and the processor 408 may send an actuation command to a particular moving mechanism 406 upon receiving a command for actuating the moving mechanism 406 from the communications module 410. The moving mechanism 406 is then actuated to eject the card from the corresponding slot 28.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An apparatus for managing a plurality of credit card payments, comprising:
a plurality of slots, each allowing for insertion of a card, wherein each slot includes:
a sensor for reading information from a card inserted into the slot; and
a moving mechanism for ejecting a card inserted into the slot;
a processor communicatively coupled with each sensor and moving mechanism associated with each slot, wherein the processor is configured for receiving data read by the sensors and sending an actuation command to the moving mechanisms; and
a communications module communicatively coupled with the processor for sending data read by the sensors and receiving commands for actuating the moving mechanisms.

2. The apparatus of claim 1, wherein a sensor comprises a magnetic strip reading mechanism.

3. The apparatus of claim 1, wherein a sensor comprises a raised lettering reading mechanism.

4. The apparatus of claim 1, wherein a sensor comprises a storage medium reading mechanism.

5. The apparatus of claim 1, wherein a moving mechanism comprises a spring activated latch that releases a loaded spring upon receiving an actuation command.

6. The apparatus of claim 1, wherein a moving mechanism comprises a motor that commences movement upon receiving an actuation command.

7. The apparatus of claim 1, wherein the processor is further configured for sending the data received from the sensors to the communications module.

8. The apparatus of claim 7, wherein the processor is further configured for sending an actuation command to a particular moving mechanism upon receiving a command for actuating the moving mechanism from the communications module.

9. The apparatus of claim 1, wherein the communications module further comprises a network interface card.

10. The apparatus of claim 1, wherein the communications module further comprises any one of a serial port, a parallel port, a USB port, an IEEE 1394 port, a wireless Bluetooth transmitter/receiver and a wireless IEEE 802.11 transmitter/receiver.

11. A system for managing a plurality of credit card payments, comprising:
a point of sale accounting system executing on a computer;
a payment processing system executing on a computer connected to a communications network and communicatively coupled with a payment gateway, wherein the payment processing system is connected to the point of sale system;
a card processing apparatus communicatively coupled with the payment processing system, the card processing apparatus comprising:
a plurality of slots, each allowing for insertion of a card, wherein each slot includes:
a sensor for reading information from a card inserted into the slot; and
a moving mechanism for ejecting a card inserted into the slot;
a processor communicatively coupled with each sensor and moving mechanism associated with each slot, wherein the processor is configured for receiving data read by the sensors and sending an actuation command to the moving mechanisms; and
a communications module communicatively coupled with the processor for sending data read by the sensors and receiving commands for actuating the moving mechanisms.

12. The system of claim 11, wherein a sensor comprises at least one of a magnetic strip reading mechanism, a raised lettering reading mechanism and a storage medium reading mechanism.

13. The system of claim 11, wherein a moving mechanism comprises at least one of a spring activated latch that releases a loaded spring upon receiving an actuation command and a motor that commences movement upon receiving an actuation command.

14. The system of claim 11, wherein the processor is further configured for sending the data received from the sensors to the communications module, which is configured for sending the data received from the sensors to the payment processing system.

15. The system of claim 14, wherein the processor is further configured for sending an actuation command to a particular moving mechanism upon receiving a command for actuating the moving mechanism from the communications module, and wherein the payment processing system is configured for sending a command for actuating the moving mechanism to the communications module upon receiving a payment acknowledgement from the payment gateway.

16. The system of claim 11, wherein the communications module further comprises a network interface card.

17. A method for managing a plurality of credit card payments, comprising:
reading information from a credit card inserted into a card processing apparatus;
establishing an account associated with the credit card, wherein a name on the credit card is associated with the account;
entering at least one charge associated with the account;
sending a payment request to a payment gateway over a communications network, wherein the payment request includes data associated with the account and any charges associated with the account;
receiving a payment acknowledgement from the payment gateway; and
sending an actuation command to a moving mechanism coupled with the credit card processing apparatus, wherein the moving mechanism is configured for ejecting the credit card when actuated.

18. The method of claim 17, further comprising:
reading information from an identification card inserted into the card processing apparatus, wherein the identification card is associated with the credit card; and
wherein establishing the account associated with the credit card includes associating any data from the identification card with the account.

19. The method of claim 18, further comprising:
transmitting a message to an owner of the card over the communications network, wherein the message includes data associated with any charges associated with the account.

20. The method of claim 19, wherein the step of transmitting a message further comprises:
transmitting an email or text message to the owner of the card, wherein the email or text message includes a copy of a receipt including any charges associated with the account.
